(19) United States
(12) Patent Application Publication
(10) Pub. No.: US 2026/0233213 A1
(43) Pub. Date: Aug. 13, 2026

(54) REVERSIBLE BOUDOUARD REACTOR AND SOLID-OXIDE ELECTROCHEMICAL CELL

(71) Applicant: NOON ENERGY, Palo Alto, CA (US)

(72) Inventors: Brooks J. HORNSTEIN, San Jose, CA (US); Pawel A. PIOTROWICZ, Santa Clara, CA (US); Christopher Ronald GRAVES, Palo Alto, CA (US); Sunjay G. MELKOTE, Sunnyvale, CA (US); Theis L. SKAFTE, Palo Alto, CA (US)

(21) Appl. No.: 19/535,781

(22) Filed: Feb. 10, 2026

Related U.S. Application Data
(60) Provisional application No. 63/756,490, filed on Feb. 10, 2025.

(51) Int. Cl. B01J 37/08; B01J 8/00; B01J 35/40; B01J 35/45

(52) U.S. Cl. CPC B01J 37/08; B01J 8/0055; B01J 35/40; B01J 35/45; B01J 2523/31

(57) ABSTRACT

Provided herein are reactors, and methods of making and processes for using the same, in which energy is reversibly stored as carbon using Boudouard reaction catalysts. Set forth herein are processes for reversibly and continuously cycling such reactors between a discharge state for providing energy and a charged state for storing energy. Also described are apparatus for coupling these reactors to solid-oxide electrochemical stacks, as well as processes for using the same.

### CROSS-REFERENCE TO RELATED APPLICATIONS

This application claims priority to, and the benefit of, U.S. Provisional Patent Application No. 63/756,490, filed Feb. 10, 2025, the entire contents of which are herein incorporated by reference in its entirety for all purposes.

### FIELD

The instant disclosure relates to carbon-oxygen batteries that include Boudouard catalytic reactors and reversibly operable solid-oxide electrochemical cells.

### BACKGROUND OF THE INVENTION

A carbon-oxygen battery operates during the charging phase by electrochemically converting carbon dioxide (CO₂) into carbon monoxide (CO) and oxygen (O₂), and by catalytically, or thermochemically, converting CO into carbon (C) and CO₂. In a discharge phase, the reactions are reversed. During discharge, a carbon-oxygen battery releases energy stored in carbon and oxygen bonds by reacting the two elements and generating carbon dioxide. This produces electrical energy and heat. See, for example, WO2014044285A1 and US20200358123A1, the entire contents of which are herein incorporated by reference in their entirety for all purposes.

Carbon-oxygen batteries lack sufficient reversibility to operate over long time periods and/or are not commercially viable due to certain economic constraints. One problem related to this is reactor design and coking of carbon on heterogeneous catalysts.

The coking problem is particularly apparent in thermal-catalytic reactions such as steam reforming of methane, dry reforming of methane, methane cracking, reverse water gas shift reactions and the hydrogenation of CO₂. Because of this problem, researchers try to avoid growing carbon on heterogeneous catalysts.

What is needed in the field to which the instant disclosure pertains are improved methods for storing carbon reversibly on heterogeneous catalysts such that a carbon-oxygen battery operates reversibility over long time periods in a commercially viable manner.

Set forth herein are solutions to this and other problems known in the field to which the instant disclosure pertains.

### SUMMARY OF THE INVENTION

In one embodiment, set forth herein is a process for reversibly and continuously storing energy in a reactor. The process includes providing a partial pressure of carbon monoxide (pCO) in the reactor above the Boudouard equilibrium partial pressure of CO (pCO_{eq}); growing carbon on a Boudouard catalyst and forming carbon dioxide (CO₂); providing a pCO in the reactor below the pCO_{eq}; and gasifying carbon from the Boudouard catalyst and forming carbon monoxide (CO). Herein, forming CO₂ refers to CO₂ as a product in the Boudouard reaction, which is 2CO↔C+CO₂.

In a second embodiment, set forth herein is a monolithic catalyst support, comprising a support with an array of channels; wherein the channels comprises, consist, or consists essentially of a Boudouard catalyst.

In a third embodiment, set forth carbon reactor that includes a monolithic catalyst support set forth herein.

### BRIEF DESCRIPTION OF DRAWINGS

FIG. 1 is a depiction of an embodiment of the chemical and mechanical cyclability of Boudouard catalyst pellets that grow and gasify carbon.

FIG. 2 shows a diagram of an embodiment of a reactor design having a monolithic carbon-growth catalyst structure.

FIG. 3 is a schematic of a packed bed carbon reactor designed with heat distribution grids that improve the thermal profile across the reactor.

FIG. 4 shows an embodiment of a fluidized bed carbon collector.

FIG. 5 shows an embodiment of a “radial flow” reactor body configuration.

FIG. 6 shows an embodiment of a system with “carbon cartridges,” which are removable carbon collectors for faster refueling.

FIG. 7 shows an embodiment of a reactor module that hosts a carbon/catalyst bed with several associated sensors including: an optical probe with a transmission- and diffusion-mode receiver, a level sensor, and a load cell.

FIG. 8 shows a permeability curve plot of Reactor Bed Permeability as a function of State of Charge or amount of carbon grown on catalyst pellets.

FIG. 9 shows 1,000 hours of cycling data showing reversible growth and gasification of carbon in a pellet packed bed. FIG. 9 demonstrates the reversibility of the Boudouard reaction and the repeatability of the Boudouard reaction rates over long time periods. FIG. 9 also demonstrates the stability of catalysts pellets.

FIG. 10 is a plot of the partial pressure of carbon monoxide as a function of temperature according to the Boudouard reaction equilibrium constant.

### DETAILED DESCRIPTION OF THE INVENTION

Provided herein are new applications and processes for growing and gasifying solid carbon by way of the Boudouard reaction. Certain embodiments herein use a novel catalyst. In some of these embodiments, the catalysts include a binder that is important for improving the efficiency of the reactor and the reactions therein. The catalysts include a binder that is important as well for mechanical stability of the Boudouard reaction catalyst pellets. Some embodiments herein use known catalysts, optionally with a binder present. In some of these embodiments, a custom designed reactor is also provided.

Provided herein are new Boudouard catalysts that have a unique metal content, binder type and amount, and are optionally shaped into useful shape configurations.

In some embodiments, the processes herein, such as the Boudouard reaction, occur at 500° C. to 900° C. In some of these embodiments, various pressures and gas mixtures are employed.

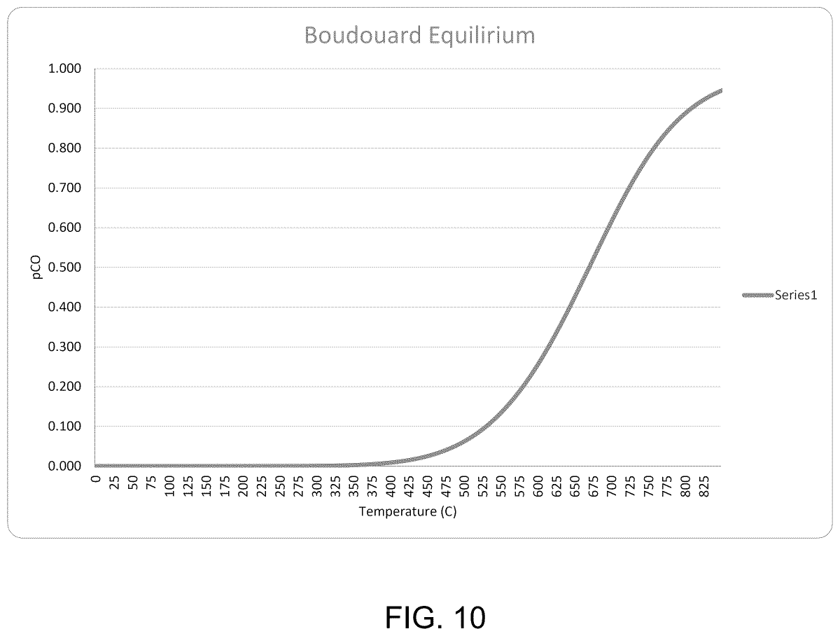

The processes here manipulate the Boudouard equilibrium constant, K_{eq}, which is a concentration ratio [pCO₂]/[pCO]². pCO is the partial pressure of CO. pCO₂ is the partial pressure of CO₂. This K_{eq} shifts as a function of temperature (T). K_{eq} is based on the relationship that the free energy ΔG of the reaction (ΔGᵣₓₙ) is related to K_{eq} by the formulas K_{eq}=exp(−ΔGᵣₓₙ/RT), wherein R is the constant, 8.314 J/mol·K and T is temperature. This can also be expressed as ΔGᵣₓₙ=−RTln(K_{eq}), wherein ln is the natural logarithm. See, for example, FIG. 10. FIG. 10 shows one example of the Boudouard equilibrium by plotting pCO as a function of temperature. Other Boudouard equilibrium plots are disclosed in U.S. Pat. No. 9,780,424 B2, for example at FIG. 11 therein, the entire contents of which are herein incorporated by reference in its entirety.

### Definitions

As used herein, the term “about,” when qualifying a number, e.g., 15% v/v, refers to the number qualified and optionally the numbers included in a range about that qualified number that includes ±10% of the number. For example, about 15% v/v includes 15% v/v as well as 13.5% v/v, 14% v/v, 14.5% v/v, 15.5% v/v, 16% v/v, or 16.5% v/v. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrase “Boudouard threshold,” means the partial pressure of carbon monoxide, above which carbon is deposited and carbon dioxide is produced and below which carbon is vaporized and reacts with carbon dioxide to produce more carbon monoxide. The Boudouard threshold is a function of temperature and will change with increases or decrease in temperature.

As used herein, the phrase “Boudouard catalyst,” refers to a material that catalyzes the formation of C and CO₂ from CO; or that produces CO by thermo-catalytically reacting C and CO₂.

As used herein, the phrase “reversibly and continuously storing energy,” refers to at least one or more chemical reactions that are reversible, continuous, and that form a reactant from which a product can be formed, in a reverse reaction, while also producing or consuming energy such as thermal energy. For example, as defined below, a reaction is reversible or bidirectional when it proceeds in both the forward and reverse direction repeatedly. A reaction is continuous when reactants may be added to the reactor simultaneous with the production of products therein. A reaction stores energy when the products of the reaction are themselves chemical reactants that can later react to reform products or form new products that released energy during the product formation.

As used herein, a process is reversible or bidirectional when the process can form chemical products from chemical reactants, and chemical reactants from chemical products repeatedly. For example, a reaction that stores energy in the form of a chemical reactant is reversible if the stored energy is released when the chemical reactant is transformed into a product and further when the released energy can be stored again when the chemical product is transformed back into a chemical reactant when energy from an external source is introduced with the chemical product. In some embodiments herein, energy is stored as solid carbon in a thermochemical reactor. This energy is released when the carbon, as a reactant, is transformed into CO and further when the CO is electrochemically oxidized to a product, CO₂. If the energy released can be stored again by electrochemically reducing the CO₂ into CO and depositing solid carbon in a thermochemical reactor using the CO, then the process is reversible.

As used herein, the phrase “substantial reduction in reaction rate,” refers to reducing the rate of a chemical reaction by at least 50% or greater.

As used herein, the phrase “partial pressure of carbon monoxide (pCO),” refers to the proportional amount of CO in a mixture of gases that include CO. For example, if a gas includes 50% CO by mole (mol %) and 50% CO₂ by mol, the partial pressure of CO would be 0.5.

As used herein, the phrase “Boudouard equilibrium pressure of carbon monoxide (pCO_{eq}),” refers to the partial pressure of CO at which the rate of carbon deposition equals the rate of carbon gasification.

As used herein the phrase “partial pressure of carbon monoxide (pCO) in the reactor above the Boudouard equilibrium partial pressure of CO (pCO_{eq}),” refers to a gas mixture that includes more CO than the amount of CO at which the rate of carbon deposition equals the rate of carbon gasification. When the pCO in the Boudouard reactor is above the pCO_{eq}, carbon deposits and CO₂ is formed.

As used herein the phrase “partial pressure of carbon monoxide (pCO) in the reactor below the Boudouard equilibrium partial pressure of CO (pCO_{eq}),” refers to a gas mixture that includes less CO than the amount of CO at which the rate of carbon deposition equals the rate of carbon gasification. When the pCO in the Boudouard reactor is below the pCO_{eq}, carbon gasifies and thermo-catalytically reacts with CO₂, if CO₂ is present, to form more CO. In some embodiments, the Boudouard reaction described herein occurs at a temperature of at least 500° C.

As used herein, the phrase “growing carbon,” refers to the process by which carbon is deposited onto a Boudouard reaction catalyst or deposited onto carbon that is already deposited onto a Boudouard reaction catalyst. Growing carbon includes the deposition of carbon.

As used herein, the phrase “gasifying carbon,” or “gasifying carbon from the Boudouard catalyst” refers to the process by which solid carbon on a Boudouard reaction catalysts reacts thermo-catalytically with CO₂ to form CO. Gasifying carbon includes the oxidation of carbon.

As used herein, the phrase “solid-oxide electrochemical stack in fuel cell mode,” refers to the use of a solid-oxide electrochemical cell to generate electricity and optionally heat by reacting a chemical to form a product. For example, a solid-oxide electrochemical cell may react CO and oxygen (O₂) to form CO₂ and generate electricity and heat.

As used herein, the phrase “solid-oxide electrochemical stack in electrolyzer mode,” refers to the use of a solid-oxide electrochemical cell to consume electricity and form chemical reactants from chemical products. For example, a solid-oxide electrochemical cell may use electricity to react CO₂ and form CO and O₂.

As used herein, the phrase “coking threshold,” refers to the amount of carbon deposited onto a catalyst such that the catalyst is no longer substantially catalytically active. Substantially catalytically active means that the catalyst can still achieve at least 20% of its maximum potential catalytic activity.

As used herein, a “reversible solid-oxide electrochemical cell (rSOC)” is a solid oxide cell that generates electricity in fuel cell mode and that uses electricity to generate a fuel product in electrolyzer mode. The rSOC operates reversibly in fuel cell mode and in electrolyzer mode depending on whether electricity is flowing out of or into the solid oxide cell, respectively. An example rSOC is found in U.S. Pat. No. 11,876,269, PASSIVE FLOW BATTERY, which issued Jan. 16, 2024, the entire contents of which are herein incorporated by reference in its entirety.

As used herein, “state-of-charge,” refers to the amount of energy remaining in a system. In a battery, state-of-charge refers to the available capacity. When a battery is fully charged, the state-of-charge is 100%. When a battery is fully discharged, the state-of-charge is 0%. Herein, when a system has 100 percent of its fuel capacity stored and available to be deployed, the state-of-charge is 100%. When a system has 0% percent of its fuel available to be deployed, the state-of-charge is 0%.

As used herein, the phrase “thermochemical reactor,” means a reactor that includes catalysts suitable for performing the Boudouard reaction

### Embodiments

In some embodiments, set forth herein is a process for reversibly and continuously storing energy in a reactor. In certain embodiments, the process includes providing a partial pressure of carbon monoxide (pCO) in the reactor above the Boudouard equilibrium partial pressure of CO (pCO_{eq}); growing carbon on a Boudouard catalyst and forming carbon dioxide (CO₂); providing a pCO in the reactor below the pCO_{eq}; and gasifying carbon from the Boudouard catalyst and forming carbon monoxide (CO). In some of these embodiments, the steps occur in the order in which they are recited.

In some embodiments, set forth herein is a process for reversibly and continuously storing energy in a reactor. In certain embodiments, the process includes providing a partial pressure of carbon monoxide (pCO) in the reactor above the Boudouard equilibrium partial pressure of CO (pCO_{eq}); growing carbon on a Boudouard catalyst and producing carbon dioxide (CO₂); providing a pCO in the reactor below the pCO_{eq}; and gasifying carbon from the Boudouard catalyst and producing carbon monoxide (CO). In some of these embodiments, the steps occur in the order in which they are recited.

In some embodiments, including any of the foregoing, the CO formed flows as a reactant to a solid-oxide electrochemical stack (herein also solid-oxide cell or SOC) in fuel cell mode. In some embodiments, the CO flows from a solid-oxide electrochemical stack in electrolyzer mode. In some of these embodiments, or in other embodiments, the CO₂ flows from a solid-oxide electrochemical stack in fuel cell mode. Depending on the operation, the CO and CO₂ may flow to an electrochemical stack and then to the thermochemical reactor and then back to an electrochemical stack. Depending on the operation, the CO and CO₂ may flow to a thermochemical reactor and then to an electrochemical stack and then back to a thermochemical reactor. In some embodiments, the flow is passive. In other embodiments, the flow is active and uses pumps, blowers, or a combination of devices to cause gas to flow in one direction. The SOC may operate reversibly. In one operation, the SOC operates as a fuel cell to generate electricity. For example, the SOC may consume C and O₂ and form CO₂ while also generating electricity. In another operation, the SOC operates as an electrolyzer cell to consume electricity and generate products. For example, the SOC may use electricity to react CO₂ and form CO or form C and O₂.

In some embodiments, including any of the foregoing, the CO₂ formed flows as a reactant to a solid-oxide electrochemical stack in electrolyzer mode.

In some embodiments, including any of the foregoing, the reactor maintains a low pressure drop across the reactor of less than 2 pounds per inch² (PSI); or less than 1 PSI. In certain embodiments, the pressure drop across the reactor is less than 0.5 PSI. In certain embodiments, the pressure drop across the reactor is about 5 PSI, about 4.5 PSI, about 4.0 PSI, about 3.5 PSI, about 3.0 PSI, about 2.5 PSI, about 2.0 PSI, about 1.5 PSI, about 1.0 PSI, about 0.5 PSI, about 0.25 PSI, about 0.1 PSI, or about 0.01 PSI.

In some embodiments, including any of the foregoing, process includes growing greater than 0.01 g carbon per 1 g of Boudouard catalyst per hour. In certain embodiments, the process includes growing at least 1 g carbon per 1 g of Boudouard catalyst per hour. In certain embodiments, the process includes growing at least 2 g carbon per 1 g of Boudouard catalyst per hour. In certain embodiments, the process includes growing at least 1 g carbon per 5 g of Boudouard catalyst per hour. In certain embodiments, the process includes growing at least 10 g carbon per 1 g of Boudouard catalyst per hour. In certain embodiments, the process includes growing at least 25 g carbon per 1 g of Boudouard catalyst per hour. In some of these embodiments, the process grows less than 100 g carbon per 1 g of Boudouard catalyst per hour; less than 50 g carbon per 1 g of Boudouard catalyst per hour; or less than 20 g carbon per 1 g of Boudouard catalyst per hour.

In some embodiments, including any of the foregoing, the process includes growing greater than 2 g carbon per 1 g of Boudouard catalyst. In some embodiments, including any of the foregoing, the process includes growing up to 20 g carbon per 1 g of Boudouard catalyst. In some embodiments, including any of the foregoing, the process includes growing greater than 0.001, 0.5, 1.0, 1.5, or 2.0 g carbon per 1 g of Boudouard catalyst. In some embodiments, the process includes growing greater than 3 g per 1 g of Boudouard catalyst. In some embodiments, the process includes growing greater than 10 g per 1 g of Boudouard catalyst.

In some other embodiments, including any of the foregoing, process includes growing at least 0.5 g or greater than 0.5 g carbon per 1 g of Boudouard catalyst. For example, the process may grow 0.5 g carbon per 1 g of Boudouard catalyst; 1.0 g carbon per 1 g of Boudouard catalyst; 1.5 g carbon per 1 g of Boudouard catalyst; 2.0 g carbon per 1 g of Boudouard catalyst; 2.5 g carbon per 1 g of Boudouard catalyst; 3.0 g carbon per 1 g of Boudouard catalyst; 3.5 g carbon per 1 g of Boudouard catalyst; 4.0 g carbon per 1 g of Boudouard catalyst; 4.5 g carbon per 1 g of Boudouard catalyst; 5.0 g carbon per 1 g of Boudouard catalyst; 5.5 g carbon per 1 g of Boudouard catalyst; 6.0 g carbon per 1 g of Boudouard catalyst; 6.5 g carbon per 1 g of Boudouard catalyst; 7.0 g carbon per 1 g of Boudouard catalyst; 7.5 g carbon per 1 g of Boudouard catalyst; 8.0 g carbon per 1 g of Boudouard catalyst; 8.5 g carbon per 1 g of Boudouard catalyst; 9.0 g carbon per 1 g of Boudouard catalyst; 9.5 g carbon per 1 g of Boudouard catalyst; 10 g carbon per 1 g of Boudouard catalyst; 100 g carbon per 1 g of Boudouard catalyst; or 1,000 g carbon per 1 g of Boudouard catalyst.

In some other embodiments, including any of the foregoing, process includes gasifying at least 0.5 g or greater than 0.5 g carbon per 1 g of Boudouard catalyst. For example, the process may grow 0.5 g carbon per 1 g of Boudouard catalyst; 1.0 g carbon per 1 g of Boudouard catalyst; 1.5 g carbon per 1 g of Boudouard catalyst; 2.0 g carbon per 1 g of Boudouard catalyst; 2.5 g carbon per 1 g of Boudouard catalyst; 3.0 g carbon per 1 g of Boudouard catalyst; 3.5 g carbon per 1 g of Boudouard catalyst; 4.0 g carbon per 1 g of Boudouard catalyst; 4.5 g carbon per 1 g of Boudouard catalyst; 5.0 g carbon per 1 g of Boudouard catalyst; 5.5 g carbon per 1 g of Boudouard catalyst; 6.0 g carbon per 1 g of Boudouard catalyst; 6.5 g carbon per 1 g of Boudouard catalyst; 7.0 g carbon per 1 g of Boudouard catalyst; 7.5 g carbon per 1 g of Boudouard catalyst; 8.0 g carbon per 1 g of Boudouard catalyst; 8.5 g carbon per 1 g of Boudouard catalyst; 9.0 g carbon per 1 g of Boudouard catalyst; 9.5 g carbon per 1 g of Boudouard catalyst; 10 g carbon per 1 g of Boudouard catalyst; 100 g carbon per 1 g of Boudouard catalyst; or 1,000 g carbon per 1 g of Boudouard catalyst.

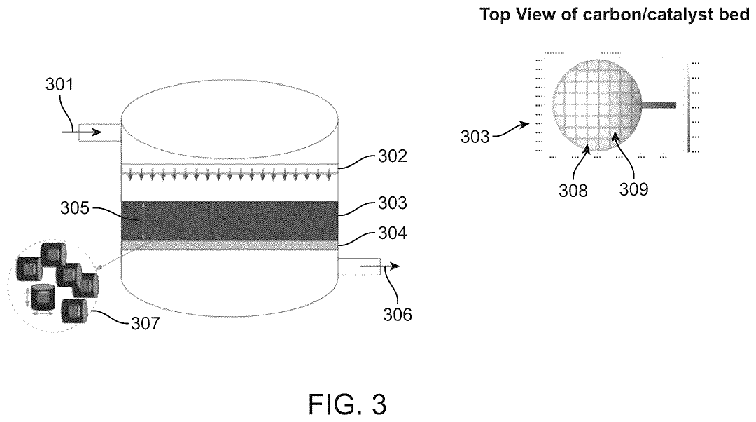

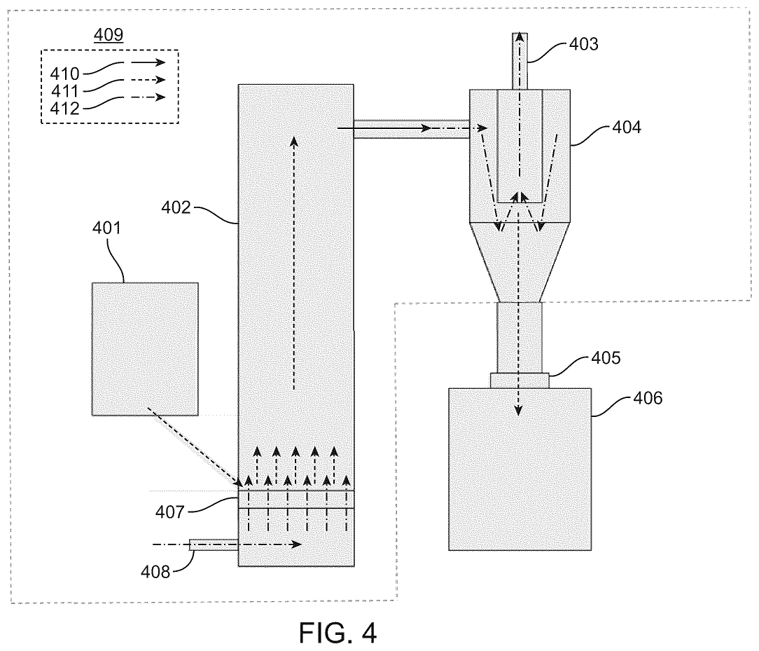

In some embodiments, including any of the foregoing, the Boudouard catalyst is: provided as pellets; on a solid support; in a packed bed; on a frit; or a combination thereof. For example, see FIG. 3 or 4. FIG. 3 shows an embodiment of a packed bed carbon reactor designed with heat distribution grids that improve the thermal profile across the reactor. FIG. 3 shows a fuel flow inlet in which a CO/CO₂ mixture enters the reactor body, which is represented by 301. FIG. 3 shows a fuel distribution manifold, which is represented by 302, and which ensures uniform and non-recirculating flow of fuel through the packed bed. FIG. 3 shows a carbon/catalyst packed bed that changes dimension based on charge state and is loaded with catalyst pellets, which is represented by 303. The pellets grow carbon and swell as carbon is deposited in conjunction with the charging of a carbon oxygen battery. The geometry and properties of the pellets change with the charge state. The dimensional changes that occur depending on the charge state are represented by 305. FIG. 3 shows a heat distribution grid, shown as 308, that ensures that the temperature of the reactor is uniform. The carbon/catalyst material is shown as 309. The heat distribution grid enhances the effective thermal conductivity of the reactor bed by ensuring low temperature gradients across the reactor. In an embodiment, if the effective thermal conductivity of catalyst pellets were 0.5 W/K/m, the addition of a conducting grid would enhance the effective thermal conductivity to 10-20 W/K/m. This allows for a small thermal gradient and conducts heat between the reactor to other components in the carbon-oxygen battery. The heat distribution grid also ensures that heat can be moved to the walls of the reactor effectively where it will be transferred to the stack. The walls of the reactor can be made from high thermal conductivity materials that can survive the reaction environment.

FIG. 3 also shows a frit, 304, that holds the carbon/catalyst packed bed and that resists carbon growth so as not to clog the frit. FIG. 3 shows a fuel flow outlet, 306, that allows a CO/CO₂ reaction mixture to leave the reactor. 307 shows that the carbon/catalyst bed is composed of catalyst pellets that change dimensions and properties depending on the charge state. In some embodiments, the Boudouard reactor is designed substantially as shown in FIG. 3.

FIG. 4 shows an embodiment of a fluidized bed carbon collector. FIG. 4 shows a catalyst hopper, 401, that is filled with a fresh catalyst. In certain embodiments, the catalyst is gravity fed into the fluidized bed reactor, which is represented as 402. Also shown is a particle frit, represented by 407, that prevents solids from moving below the fuel injection region and that distributes fluid evenly in the fluidized bed. Also shown is a fluidized bed reactor, 402, where the Boudouard reaction occurs. In the fluidized bed reactor are catalyst(s) that are fluidized and circulate in this region until it is full of carbon. The catalyst is fluidized with fuel flow, and that the fuel flow needs to be high enough to continuously fluidize particles with size/mass that dynamically varies over time. Once carbon is deposited onto the catalyst, the catalyst leaves the reactor to the cyclone separator, shown as 404, along with the fuel flow. Also shown is a cyclone separator, shown as 404, that separates the fluid flow from the particles by creating a low pressure region in the center via the cyclone effect. FIG. 4 also shows a fuel inlet, 408, in which fuel gas enters the reactor here. FIG. 4 also shows a fuel outlet, 403, where fuel exits the reactor after it is separated from the solids. There is also a high temperature flange, 405, that is used to flange off the carbon collection drum, shown as 406, from the cyclone region. This facilitates moving and collecting carbon. 410 represents the filled catalyst (i.e., charged) flow path. 411 represents the fresh catalyst (i.e., uncharged) flow path. 412 represents the fuel flow path. 409 identifies the Hot Box Zone. In some embodiments, the Boudouard reactor is designed substantially as shown in FIG. 4.

In some embodiments, including any of the foregoing, the Boudouard catalyst, or a solid support on which the Boudouard catalyst is disposed, has a flow permeability of 5×10⁻¹³ m² to 5×10⁻⁹ m².

In some embodiments, including any of the foregoing, the Boudouard catalyst, or a solid support on which the Boudouard catalyst is disposed, has a flow permeability of 5×10⁻¹² m² to 5×10⁻¹⁰ m².

In certain embodiments, the Boudouard catalyst, or a solid support on which the Boudouard catalyst is disposed, has a flow permeability of 5×10⁻¹² m². In certain embodiments, the Boudouard catalyst, or a solid support on which the Boudouard catalyst is disposed, has a flow permeability of 5×10⁻¹¹ m². In certain embodiments, the Boudouard catalyst, or a solid support on which the Boudouard catalyst is disposed, has a flow permeability of 5×10⁻¹⁰ m². In certain embodiments, the Boudouard catalyst, or a solid support on which the Boudouard catalyst is disposed, has a flow permeability of 5×10⁻⁹ m².

In certain embodiments, the Boudouard catalyst, or a solid support on which the Boudouard catalyst is disposed, has a flow permeability of 1×10⁻¹¹ m². In certain embodiments, the Boudouard catalyst, or a solid support on which the Boudouard catalyst is disposed, has a flow permeability of 1×10⁻¹⁰ m². In certain embodiments, the Boudouard catalyst, or a solid support on which the Boudouard catalyst is disposed, has a flow permeability of 1×10⁻⁹ m².

In some embodiments, including any of the foregoing, the solid support includes channels; and wherein the channels include, consist, or consist essentially of the Boudouard catalyst. The Boudouard catalyst may fill the channels. In other embodiments, the Boudouard catalyst may be adhered to the walls of the channels. In still other embodiments, the Boudouard catalyst may be incorporated into, or embedded in, the walls of the channels. For example, in some embodiments, including any of the foregoing, the solid support includes channels that are lined with the Boudouard catalyst. In certain of these embodiments, carbon growth would fill the walls, and the channel will be sized to allow free gas flow and this carbon growth.

In some embodiments, including any of the foregoing, the solid support is porous.

In some embodiments, including any of the foregoing, the solid support has a mesh permeability equal to or greater than 1.1*10⁻¹¹ m². Having a mesh permeability equal to or greater than 1.1*10⁻¹¹ m² is useful for avoiding gas pressure buildup while still securing the catalyst through charge and discharge cycles.

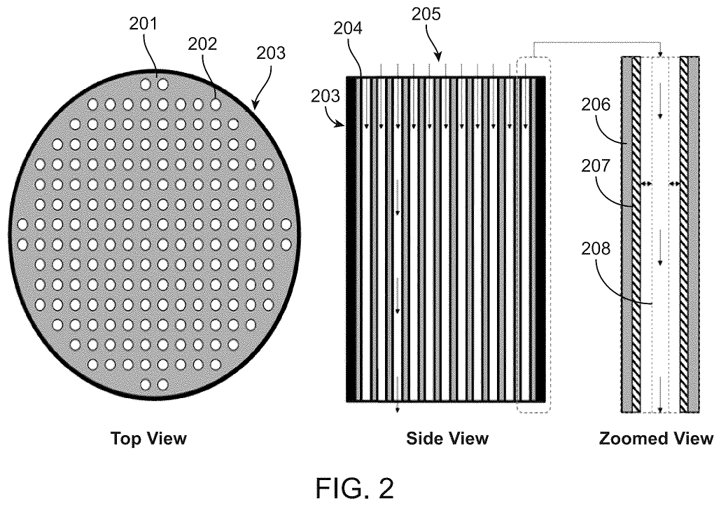

In some embodiments, including any of the foregoing, the solid support is a metal oxide, a metal, or a carbon-based material. See FIG. 2, which is described in more detail below. In some embodiments, the Boudouard reactor includes a solid support substantially as shown in FIG. 2.

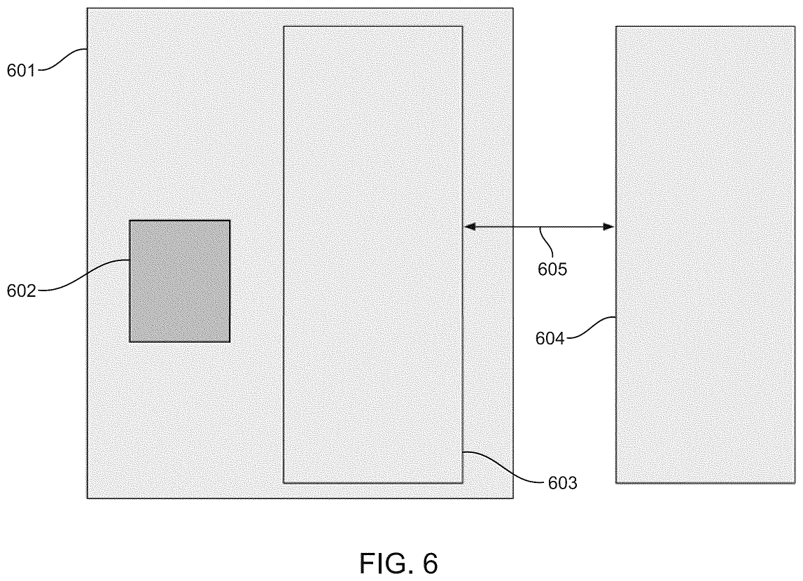

In some embodiments, including any of the foregoing, the Boudouard catalyst is disposed on a removable cartridge. For example, see FIG. 6. FIG. 6 shows an embodiment of a system with “carbon cartridges,” which are removable carbon collectors for faster refueling. 601 represents a hot box that contains both a stack of electrochemical cells and a carbon collector. The solid-oxide electrochemical stack is represented by 602 and the carbon collector is represented by 603. Reaction arrow 605 represents the ability of the carbon collector to be physically moved outside or, or back into, the hot box (601). The carbon collector moved outside of the hot box (601) is represented by 604.

In some embodiments, including any of the foregoing, the reactor has a 100% state-of-charge. The state-of-charge or SOC is a representation of the amount of carbon deposited onto the Boudouard catalyst or catalyst pellets. A 100% SOC represents the maximum amount of carbon deposited onto the Boudouard catalyst or catalyst pellets that can still participate in reversible energy storage reactions.

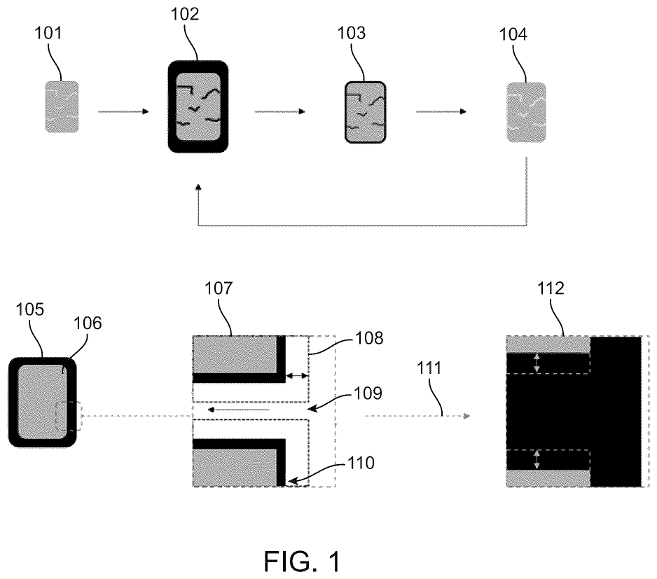

In some embodiments, including any of the foregoing, the Boudouard catalyst changes dimensions as carbon grows and gasifies. For example, see FIG. 1. FIG. 1 shows Boudouard catalyst pellets growing and gasifying carbon. In FIG. 1, the fresh catalyst pellet is shown as 101. This pellet includes a metal such as Ni, Co, or Fe. The pellet includes a binder and is porous. The pellet may have internal cracks or voids onto which carbon may be deposited. Carbon may be deposited on the peripheral surface or within the internal voids or pores in the pellet. In some embodiments, the internal cracks or voids are referred to herein as pores. During a Boudouard reaction charging cycle, when the partial pressure of carbon monoxide (CO) is above the equilibrium pressure, carbon is deposited onto the pellet and carbon dioxide (CO₂) is formed. The deposited carbon causes the pellet to swell and change in physical dimension. This change in physical dimension typically means the catalyst increase in total size or volume. This is shown as 102. During a discharge, the carbon that is deposited on the catalyst pellet is gasified and reacts with CO₂ to form CO. As this occurs, as shown in 103 in FIG. 1, the pellet reduces in size and returns to the size before it was swollen with carbon. If all the carbon, or all of the accessible carbon is released (i.e., gasified) from the catalyst pellet, then the catalyst is in a completely discharged state, which is shown as 104 in FIG. 1. In the bottom half of FIG. 1, the physical dimension changes of the pellet are detailed. The catalyst pellet is represented by 106. The carbon that grows or is deposited on the catalyst pellet during a charge cycle, is represented by 105. 107 in FIG. 1 shows a zoomed in view of a porous region of the catalyst pellet. 107 points to the pellet wall and shows carbon growing at 110. 109 represents a pore through which carbon can enter the porous region of the catalyst pellet and deposit; or through which gasified carbon can exit the porous region of the catalyst pellet. 108 shows the volume of the catalyst pellet where there is still available space for potential growth of additional carbon during a charge cycle. Reaction arrow 111 represents further growth of carbon during a charge cycle. The state when the pellet is fully charged is shown in FIG. 1 as 112.

In some embodiments, including any of the foregoing, the Boudouard catalyst includes a binder.

In some embodiments, including any of the foregoing, the binder is selected from a carbon-based binder, silicon-based binder, aluminum-based binder or a mineral-based binder.

In some embodiments, including any of the foregoing, the binder is a carbon-based binder selected from methyl cellulose, carbon black, lignin derivatives, sugar, or corn starch. In some embodiments, including any of the foregoing, the binder is coal tar pitch, petroleum pitch, phenolic resins, thermoset resins, furfuryl alcohol resins, novolac resins, polyacrylonitrile-derived systems, coke, char, graphite, or biochar.

In some embodiments, including any of the foregoing, the binder is a mineral-based binder selected from alumina, ceria, silica, silicon oxide, zeolite, or a combination thereof.

In some embodiments, including any of the foregoing, the CO has: (a) an inlet velocity of 30 standard cubic centimeters per minute (SCCM); (b) an inlet velocity of about 290 mm/minute; (c) an inlet velocity of about 4.85*10⁻³ m/sec; (d) a molar flow of about 0.67 mol/hour; (e) a gas flux of at least 0.02 mol/hour/cm²; (f) a gas flux of at least 10 mol/hour/cm²; (g) a weight hour space velocity (WHSV) of about 2.68*10⁻² mol/gcatalyst/hr; or a combination thereof of (a), (b), (c), (d), (e), (f), or (g).

In some embodiments, including any of the foregoing, the pressure in the reactor is less than 2 atm. In certain embodiments, the pressure is less than 1 atm. In certain embodiments, the pressure is less than 0.5 atm. In certain embodiments, the pressure is about 2 atm. In certain embodiments, the pressure is about 1 atm. In certain embodiments, the pressure is about 0.5 atm.

In some embodiments, including any of the foregoing, the pressure in the reactor is 5 atm or higher.

In some embodiments, including any of the foregoing, the process is reversible.

In some embodiments, including any of the foregoing, the partial pressure of pCO₂ and pCO sum to 1, which means 100% of the atmosphere is made up of the gases for which a partial pressure is described. For example, when the partial pressure of pCO₂ and pCO sum to 1, this means that the atmosphere is made up of CO₂ and CO.

In some embodiments, including any of the foregoing, the process operates at a temperature equal to, or greater than, 500° C. and less than, or equal to, 900° C. For example, the temperature may be 500° C.; 550° C.; 600° C.; 650° C.; 700° C.; 750° C.; 800° C.; 850° C.; or 900° C. In some embodiments, including any of the foregoing, the process operates at a temperature equal to, or greater than, 700° C. and less than, or equal to, 800° C. In some embodiments, including any of the foregoing, the process operates at a temperature equal to, or greater than, 500° C. and less than, or equal to, 850° C.

In some embodiments, including any of the foregoing, the temperature is 550° C., 600° C., 650° C., 700° C., 750° C., 800° C., or 850° C.

In some embodiments, including any of the foregoing, the temperature is at least 650° C. and the pCO is at least 0.5 or higher during the step of growing carbon on the Boudouard catalyst and forming CO₂.

In some embodiments, including any of the foregoing, the temperature is at least 750° C. and the pCO is at least 0.78 or higher during the step of growing carbon on the Boudouard catalyst and forming CO₂.

In some embodiments, including any of the foregoing, the temperature is at least 750° C. and the pCO is at least 0.51 or higher during the step of growing carbon on the Boudouard catalyst and forming CO₂.

In some embodiments, including any of the foregoing, the reactor is coupled in a loop with a solid-oxide electrochemical stack.

In some embodiments, including any of the foregoing, the solid-oxide electrochemical stack operates in fuel cell mode and electrolyzer mode.

In some embodiments, including any of the foregoing, the solid-oxide electrochemical stack operates reversibly in fuel cell mode and electrolyzer mode.

In some embodiments, including any of the foregoing, process includes cycling the process for at least 1,000 cycles without a substantial reduction in reaction rate.

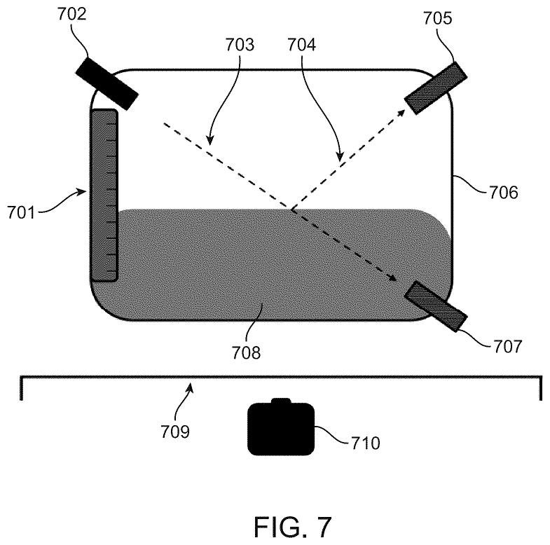

In some embodiments, including any of the foregoing, process includes measuring the state-of-charge (S-O-C) using optical measurements, infrared measurements, ultrasonic measurements, electrical conductivity measurements, impedance measurements, or a combination thereof. In some embodiments, S-O-C is measured by the pressure drop in the system. For example, pressure drop may be measured using a pressure transducer. For example, in some embodiments, a S-O-C of 100 is when the system operates at 5 PSI, and when the system has a pressure drop to 1 PSI, then the S-O-C is closer to 0. S-O-C is also measured in some embodiments by analyzing the gas composition in the reactor. The gas composition includes the relative amount of CO and CO₂. In some other embodiments, S-O-C is measured by weighing the Boudouard catalysts. For example, a gas analyzer may be used and the amount of gas, its composition, and then amount of carbon deposited is mathematically determined math. In another example, a scale or load cell is used to measure a weight change of the catalysts. In some embodiments, including any of the foregoing, process includes measuring the state-of-charge using a load cell mounted/fixed either internally or externally. In some embodiments, including any of the foregoing, the load cell measures changes in weight that are directly correlated with carbon growth. For example, see FIG. 7. FIG. 7 shows an embodiment of a reactor module that hosts the carbon/catalyst bed with several associated sensors including: an optical probe with a transmission- and diffusion-mode receiver, a level sensor, and a load cell. Other reactor module embodiments are contemplated herein, which could include other module designs. FIG. 7 shows a set-up for measuring the amount of carbon in a catalyst bed using optical measurements. The reactor body is generally shown by 706. An optical probe, represented by 702, is shown that transmits light in a light path, shown by 703, onto a catalyst bed having carbon deposited thereon. The carbon/catalyst bed is shown as 708. The diffuse reflectance of the light transmitted by the optical probe (702) is shown as 704. The diffuse reflectance light is measured by the diffuse optical receiver, which is represented by 705. Also shown is a level sensor, 701, that measures the level of carbon and catalyst in the catalyst bed. The light transmitted by the optical probe, 702, may also transmit through the carbon/catalyst bed and be measured by a transmission optical receiver, which is shown as 707. The amount of carbon in the catalyst bed may also be measured by observing the weight of the catalyst bed change as carbon grows thereon or gasifies therefrom. A load cell, represented by 710, may measure the weight of the catalyst bed through a force distribution platform, which is represented by 709.

In some embodiments, including any of the foregoing, the Boudouard catalyst includes at least one metal selected from nickel (Ni), molybdenum (Mo), cobalt (Co), iron (Fe), praseodymium (Pr), or combinations thereof.

In some embodiments, including any of the foregoing, the Boudouard catalyst includes nickel (Ni).

In some embodiments, including any of the foregoing, the Boudouard catalyst includes molybdenum (Mo).

In some embodiments, including any of the foregoing, the Boudouard catalyst includes cobalt (Co).

In some embodiments, including any of the foregoing, the Boudouard catalyst includes iron (Fe).

In some embodiments, including any of the foregoing, the Boudouard catalyst includes praseodymium (Pr).

In some embodiments, including any of the foregoing, the Boudouard catalyst is a pellet shaped as a sphere, a cube, a rectangle, a bilobe, a trilobe, a horseshoe, or a cylinder.

In some embodiments, including any of the foregoing, the Boudouard catalyst is a pellet having a diameter, height, or both, from about 0.5 mm to about 10 mm. For example, the Boudouard catalyst pellet may have a diameter, height, or both, of 0.5 mm. In other embodiments, the Boudouard catalyst pellet may have a diameter, height, or both, of 1.0 mm. In certain embodiments, the Boudouard catalyst pellet has a diameter, height, or both, of 0.5 mm; 1 mm; 1.5 mm; 2 mm; 2.5 mm; 3 mm; 3.5 mm; 4 mm; 4.5 mm; 5 mm; 5.5 mm; 6 mm; 6.5 mm; 7 mm; 7.5 mm; 8 mm; 8.5 mm; 9 mm; 9.5 mm; or 10 mm.

In some embodiments, including any of the foregoing, the Boudouard catalyst is a pellet having a diameter, height, or both, equal to 1 mm, 3 mm, or 5 mm.

In some embodiments, including any of the foregoing, the Boudouard catalyst is porous.

In some embodiments, set forth herein is a monolithic catalyst support, including a support with an array of channels; wherein the channels includes, consist, or consists essentially of a Boudouard catalyst. In some embodiments, the Boudouard reactor includes a catalyst support substantially as shown in FIG. 2. For example, see FIG. 2. FIG. 2 shows an embodiment of a reactor design having a monolithic carbon-growth catalyst structure. In one embodiment, the reactor has a cylindrical shape. Viewed from the top-down, the reactor includes a bulk monolithic catalytic support, shown as 201. The support is porous and includes gas flow channels, 202. The vessel walls are shown as 203. The support may be made of, but is not limited to, ceramics. Ceramics that are suitable for use include, but are not limited to, alumina, fused silica, and quartz. In other embodiments, the support may be made of, but is not limited to, metal or metallics. Suitable metallics include, but are not limited to, 304 stainless steel, 316 stainless steel, Inconel 600, Inconel 625, Hastelloy C22, Hastelloy C276, or Hastelloy X. Depending on the specific reactor design, the shape and spacing of the monolithic catalyst support can vary. FIG. 2 shows one embodiment of a bulk, mechanically robust structure with minimal flow resistance (pressure drop), and room within the channels for carbon growth is described as shown. Viewed from the side, FIG. 2 shows that the porous gas flow channels extend vertically along the major axis of the reactor's cylindrical shape. These vertical channels are labeled as 204. Gas flows [i.e., fuel flow in solid oxide fuel cell (SOFC) mode] through these vertical channels as represented by 205. The far right shows a zoomed view of the vertical channel. The catalyst support is shown as 206. Carbon growth is shown as 207. The internal space represented by 208 shows available room or space for additional carbon growth. The straight arrows show the direction of gas flow, which may be fuel when operating in SOFC mode.

In some embodiments, including any of the foregoing, the channels are vertically aligned.

In some embodiments, including any of the foregoing, the monolith is a porous foam, a 3d printed structure with grid patterns, optionally wherein the monolithic catalyst solid support includes both macro porosity and/or porogens for micro porosity.

In some embodiments, including any of the foregoing, the support is made of a ceramic, a metal, or a combination thereof.

In some embodiments, including any of the foregoing, the ceramic is selected from alumina, fused silica, quartz, or a combination thereof.

In some embodiments, including any of the foregoing, the metal is selected from 304 stainless steel, 316 stainless steel, 310s stainless steel, 321 h stainless steel Inconel 600, Inconel 625, Hastelloy C22, Hastelloy C276, Hastelloy X, or a combination thereof.

In some embodiments, including any of the foregoing, the channels are periodically spaced.

In some embodiments, including any of the foregoing, the channels are randomly spaced.

In some embodiments, including any of the foregoing, the monolithic catalyst support is cylindrically shaped or rectangularly shaped.

In some embodiments, set forth herein is a carbon reactor including the monolithic catalyst support set forth herein.

In some embodiments, set forth herein is a carbon reactor for implementing the process set forth herein.

In some embodiments, including any of the foregoing, the process includes contacting carbon on a Boudouard catalyst with carbon dioxide (CO₂) during the steps that include providing a pCO in the reactor below pCO_{eq}; and gasifying carbon from the Boudouard catalyst and forming carbon monoxide (CO).

In some embodiments, including any of the foregoing, the step of growing carbon on the Boudouard catalyst and forming CO₂ occurs by contacting the Boudouard catalyst with CO above the pCO_{eq}.

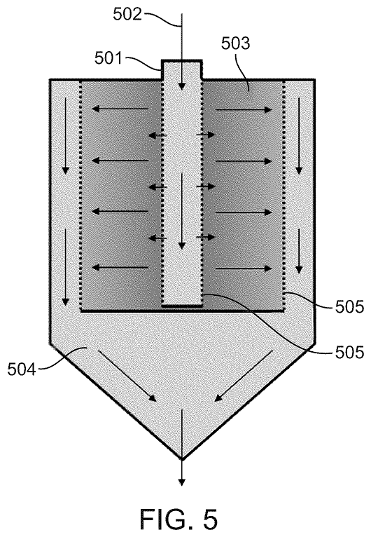

Other embodiments are contemplated herein. For example, see FIG. 5. FIG. 5 shows an embodiment of a “radial flow” reactor body configuration. The walls (505) of the reactor body (503) and internal gas chamber (501) are made of robust meshes. This allows gas flow, shown as 502, through the meshes without breaking due to mechanical stress from carbon growth. Gas flows in initially through the internal gas chamber (501) at 502 (the “axial” direction), and then gas exits through the mesh walls, represented by 505, in the horizontal (“radial”) direction into the reactor body. Gas will continue to flow through the reactor body in the radial direction, exiting into the outer gas chamber, which is shown as 504. This is an otherwise empty chamber that redirects gas flow from the radial direction back into an axial flow.

In some embodiments, including any of the foregoing, set forth herein is a carbon reactor comprising a monolithic catalyst support described herein.

In some embodiments, including any of the foregoing, set forth herein is a carbon reactor for implementing a process described herein.

### EXAMPLES

Instruments used in the Examples included Alicat mass flow controllers (MFCs), and a thermogravimetric analyze (TGA) from Netsch. Also employed were other mass flow controllers, and gas composition sensors for measuring CO and CO₂ concentration.

### Example 1

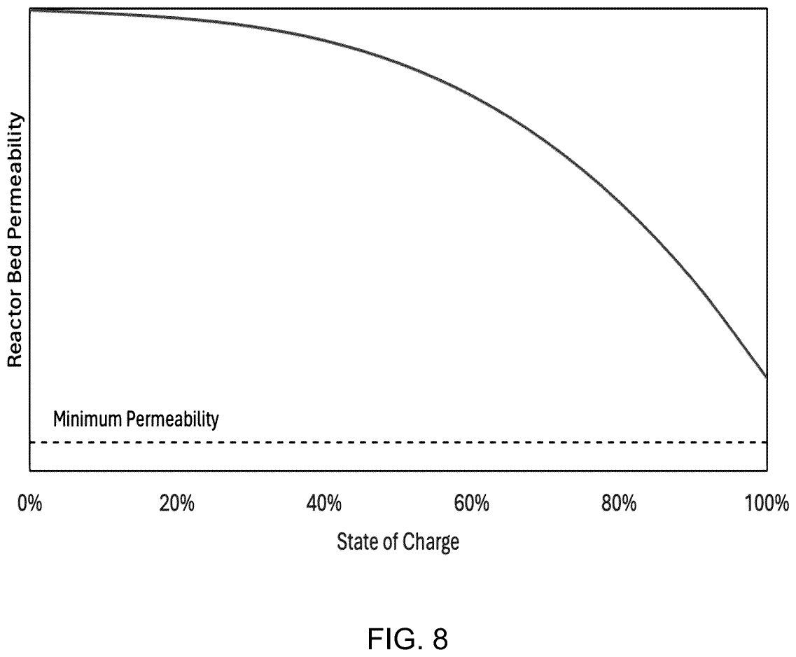

FIG. 8 was produced in a test chamber with catalyst pellets (Ni-based catalysts in a carbon-based binder, 3 mm) under typical reaction conditions (flow of CO/CO₂ gas, ambient pressure, greater than 500° C. temperature). The Ni-based catalysts in a carbon-based binder pellets is an example of a heterogenous catalyst because the catalyst includes more than one type of material. Gas pressure was measured at the inlet to the reactor and at the outlet, and pressure drop was calculated by subtracting the outlet pressure from the inlet pressure. In this example, the pressure drop was 6 pounds per squire inch (PSI) at 100% state of charge. State of charge was measured based on the reaction chemistry, i.e., the relative amount of products and reactants. This included a manual calculation based on the gas composition. Permeability was measured using Darcy's Law. Darcy's law is an equation that describes the flow of a fluid through a porous medium. Darcy's law is analogous to Ohm's law in electrostatics, linearly relating the volume flow rate of the fluid to the hydraulic head difference (which is often just proportional to the pressure difference) via the hydraulic conductivity. In fact, the Darcy's law is a special case of the Stokes equation for the momentum flux, in turn derived from the momentum Navier-Stokes equation.

The minimum permeability was a determination from systems modeling. In this example, the minimum permeability was 1e⁻¹² m², but this value can change with configuration of the carbon collector, configuration of the system, and/or target metrics.

Below this permeability, system requirements (specifically, pump sizing, heat transfer requirement) get too limiting. Round trip efficiency (RTE) would also suffer and the capital expenditure to overcome this limitation would have been economically prohibitive.

### Example 2

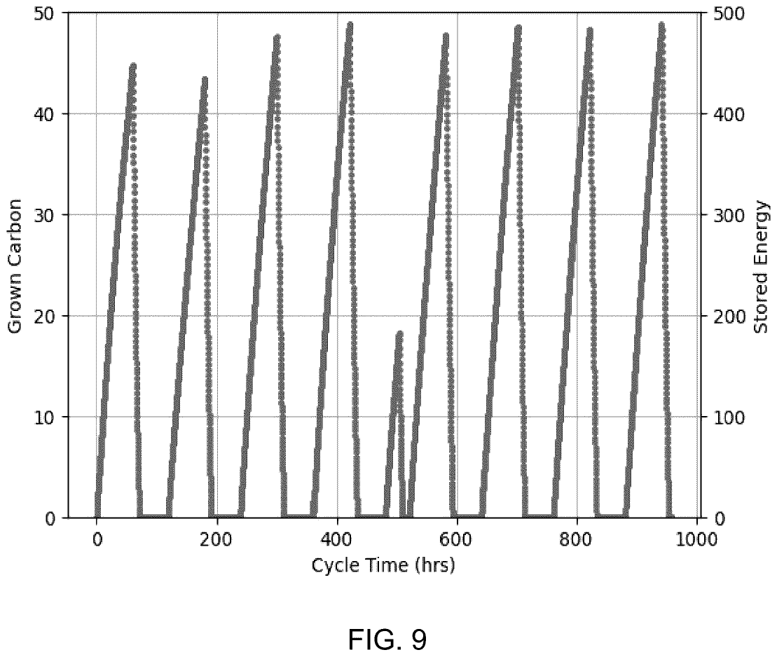

25 g of catalyst (Ni-based catalysts in a carbon-based binder, 3 mm) was placed in a 6.4 mm inner diameter (ID) quartz reactor tube. Growth and gasification steps were 60 hours long each. Growth was 0.25 standard liters per min (sl/m) (4.85E-03 m/s or 2.68E-02 mol/gcat/hr) at pCO=0.9. Herein, standard is a measured volume of gas at 1 atm and 0° C. Discharge, or gasification of carbon, was 0.25 sl/m (4.85E-03 m/s or 2.68E-02 mol/gcat/hr) at pCO=0.05. The test included 8 full cycles, wherein 1 cycle equaled 60 hours growth and 60 hours gasification, and one short cycle in the middle, at around 500 hours, that had to be stopped early for system maintenance. The test chamber was hot and had gas flow continuously for these 1000 hours. The temperature was about 500° C. to 900° C. and in some examples, 700° C. to 800° C. Pressure was 1 bar throughout the entire run. Growth rate was average ~0.03 g C/gcat/hr (0.31 W/gcat) and gasification rate was an average of ~−0.16 gC/gcat/hr (−1.5 W/gcat). Herein, C/gcat/hr means carbon per gram of catalyst per hour. The results are shown in FIG. 9.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. A process for reversibly and continuously storing energy in a reactor, the process comprising:
providing a partial pressure of carbon monoxide (pCO) in the reactor above the Boudouard equilibrium partial pressure of CO (pCO_{eq});
growing carbon on a Boudouard catalyst and producing carbon dioxide (CO₂);
providing a pCO in the reactor below the pCO_{eq}; and
gasifying carbon from the Boudouard catalyst and producing carbon monoxide (CO).

2. The process of claim 1, wherein the CO formed flows as a reactant to a solid-oxide electrochemical stack in fuel cell mode.

3. The process of claim 1 or 2, wherein the CO₂ formed flows as a reactant to a solid-oxide electrochemical stack in electrolyzer mode.

4. The process of any one of claims 1-3, wherein the CO flows from a solid-oxide electrochemical stack in electrolyzer mode.

5. The process of any one of claims 1-4, wherein the CO₂ flows from a solid-oxide electrochemical stack in fuel cell mode.

6. The process of any one of claims 1-5, wherein the reactor maintains a low pressure drop across the reactor of less than 2 pounds per inch² (PSI); or less than 1 PSI.

7. The process of any one of claims 1-6, comprising growing greater than 0.01 g carbon per 1 g of Boudouard catalyst per hour.

8. The process of any one of claims 1-7, comprising growing greater than 0.5 g carbon per 1 g of Boudouard catalyst.

9. The process of any one of claims 1-8, comprising growing greater than 2 g carbon per 1 g of Boudouard catalyst.

10. The process of any one of claims 1-9, comprising growing up to 20 g carbon per 1 g of Boudouard catalyst.

11. The process of any one of claims 1-10, wherein the Boudouard catalyst is:
(a) provided as pellets;
(b) on a solid support;
(c) in a packed bed;
(d) on a frit;
(e) or a combination thereof.

12. The process of any one of claims 1-11, wherein the Boudouard catalyst, or a solid support on which the Boudouard catalyst is disposed, has a flow permeability of 5×10⁻¹³ m² to 5×10⁻⁹ m².

13. The process of any one of claims 1-12, wherein the Boudouard catalyst, or a solid support on which the Boudouard catalyst is disposed, has a flow permeability of 5×10⁻¹² m² to 5×10⁻¹⁰ m².

14. The process of any one of claims 11-13, wherein the solid support comprises channels; and wherein the channels comprise, consist, or consist essentially of the Boudouard catalyst.

15. The process of any one of claims 11-14, wherein the solid support comprises channels that are lined with the Boudouard catalyst.

16. The process of any one of claims 11-15, wherein the solid support is porous.

17. The process of claim 16, wherein the solid support has a mesh permeability equal to or greater than 1.1*10⁻¹¹ m².

18. The process of any one of claims 11-17, wherein the solid support is a metal oxide, a metal, or a carbon-based material.

19. The process of any one of claims 1-18, wherein the Boudouard catalyst is disposed on a removable cartridge.

20. The process of any one of claims 1-19, wherein the reactor has a 100% state-of-charge.

21. The process of any one of claims 1-20, wherein the Boudouard catalyst changes dimensions as carbon grows and gasifies.

22. The process of any one of claims 1-21, wherein the Boudouard catalyst comprises a binder.

23. The process of any one of claims 1-22, wherein the CO has:
(a) an inlet velocity of 30 SCCM;
(b) an inlet velocity of about 290 mm/min;
(c) an inlet velocity of about 4.85*10⁻³ m/sec;
(d) a molar flow of about 0.67 mol/hr;
(e) a gas flux of at least 0.02 mol/hr/cm²;
(f) a gas flux of at least 10 mol/hr/cm²;
(g) a weight hour space velocity (WHSV) of about 2.68*10⁻² mol/gcatalyst/hr;
or a combination thereof of (a), (b), (c), (d), (e), (f), or (g).

24. The process of any one of claims 1-23, wherein the pressure in the reactor is less than 2 atm.

25. The process of any one of claims 1-24, wherein the process is reversible.

26. The process of any one of claims 1-25, wherein the partial pressure of pCO₂ and pCO sum to 1.

27. The process of any one of claims 1-26, wherein the process operates at a temperature equal to, or greater than, 500° C. and less than, or equal to, 900° C.

28. The process of any one of claims 1-27, wherein the process operates at a temperature equal to, or greater than, 700° C. and less than, or equal to, 800° C.

29. The process of any one of claims 1-27, wherein the process operates at a temperature equal to, or greater than, 500° C. and less than, or equal to, 850° C.

30. The process of claim 27, wherein the temperature is 550° C., 600° C., 650° C., 700° C., 750° C., 800° C., or 850° C.

31. The process of any one of claims 27-30, wherein the temperature is at least 650° C. and the pCO is at least 0.5 or higher during the step of growing carbon on the Boudouard catalyst and forming CO₂.

32. The process of any one of claims 27-31, wherein the temperature is at least 750° C. and the pCO is at least 0.51 or higher during the step of growing carbon on the Boudouard catalyst and forming CO₂.

33. The process of any one of claims 27-32, wherein the temperature is at least 750° C. and the pCO is at least 0.78 or higher during the step of growing carbon on the Boudouard catalyst and forming CO₂.

34. The process of any one of claims 1-33, wherein the pressure in the reactor is about 1 atm.

35. The process of any one of claims 1-34, wherein the pressure in the reactor is less than 10 atm.

36. The process of any one of claims 1-35, wherein the pressure in the reactor is less than 2 atm.

37. The process of any one of claims 1-36, wherein the reactor is coupled in a loop with a solid-oxide electrochemical stack.

38. The process of claim 37, wherein the solid-oxide electrochemical stack operates in fuel cell mode and electrolyzer mode.

39. The process of any one of claims 1-38, comprising cycling the process for at least 1,000 cycles without a substantial reduction in reaction rate.

40. The process of any one of claims 1-39, further comprising measuring the state-of-charge using optical measurements, infrared measurements, ultrasonic measurements, electrical conductivity measurements, impedance measurements, or a combination thereof.

41. The process of any one of claims 1-40, further comprising measuring the state-of-charge using a load cell mounted/fixed either internally or externally in the reactor.

42. The process of claim 41, wherein the load cell measures changes in weight that are directly correlated with carbon growth.

43. The process of any one of claims 1-42, wherein the Boudouard catalyst comprises at least one metal selected from nickel (Ni), molybdenum (Mo), cobalt (Co), iron (Fe), praseodymium (Pr), or combinations thereof.

44. The process of any one of claims 1-43, wherein the Boudouard catalyst comprises nickel (Ni).

45. The process of any one of claims 1-44, wherein the Boudouard catalyst is a pellet shaped as a sphere, a cube, a rectangle, a bilobe, a trilobe, a horseshoe, or a cylinder.

46. The process of any one of claims 1-45, wherein the Boudouard catalyst is a pellet having a diameter, height, or both, from about 0.5 mm to about 10 mm.

47. The process of claim 46, wherein the Boudouard catalyst is a pellet having a diameter, height, or both, equal to 1 mm, 3 mm, or 5 mm.

48. The process of any one of claims 1-47, wherein the Boudouard catalyst is porous.

49. The process of any one of claims 22-48, wherein the binder is selected from a carbon-based binder, silicon-based binder, aluminum-based binder or a mineral-based binder.

50. The process of claim 49, wherein the binder is a carbon-based binder selected from methyl cellulose, carbon black, lignin derivatives, sugar, or corn starch.

51. The process of claim 49, wherein the binder is a mineral-based binder selected from alumina, ceria, silica, zeolite, or a combination thereof.

52. A monolithic catalyst support, comprising
a support with an array of channels;
wherein the channels comprises, consist, or consists essentially of a Boudouard catalyst.

53. The monolithic catalyst support of claim 52, wherein the channels are vertically aligned.

54. The monolithic catalyst support of claim 52 or 53, wherein the monolith is a porous foam, a 3d printed structure with grid patterns, optionally wherein the monolithic catalyst solid support comprises both macro porosity and/or porogens for micro porosity.

55. The monolithic catalyst support of any one of claims 52-54, wherein the support is made of a ceramic, a metal, or a combination thereof.

56. The monolithic catalyst support of claim 55, wherein the ceramic is selected from alumina, fused silica, quartz, or a combination thereof.

57. The monolithic catalyst support of claim 55, wherein the metal is selected from 304 stainless steel, 316 stainless steel, 310s stainless steel, 321 h stainless steel Inconel 600, Inconel 625, Hastelloy C22, Hastelloy C276, Hastelloy X, or a combination thereof.

58. The monolithic catalyst support of any one of claims 52-57, wherein the channels are periodically spaced.

59. The monolithic catalyst support of any one of claims 52-57, wherein the channels are randomly spaced.

60. The monolithic catalyst support of any one of claims 52-59, wherein the monolithic catalyst support is cylindrically shaped or rectangularly shaped.

61. A carbon reactor comprising the monolithic catalyst support of any one of claims 52-60.

62. A carbon reactor for implementing the process of any one of claims 1-51.
